(19) United States
(12) Patent Application Publication
(10) Pub. No.: US 2012/0162637 A1
(43) Pub. Date: Jun. 28, 2012

(54) Detection in Spatial Multidimensional Chromatography

(75) Inventors: Sebastiaan Eeltink, Brussels (BE); Peter J. Schoenmakers, Oudkarspel (NL)

(73) Assignee: DIONEX BENELUX B.V., Amsterdam (NL)

(21) Appl. No.: 13/394,487

(22) PCT Filed: Sep. 7, 2010
(86) PCT No.: PCT/EP2010/005469

§ 371 Date: Mar. 6, 2012

(30) Foreign Application Priority Data
Sep. 7, 2009 (DE) 10 2009 040 186.5

(51) Int. Cl. G01N 30/00; H01J 49/26; G01N 21/35; G01J 3/44; G01N 21/33

(52) U.S. Cl. 356/51; 73/61.52; 356/301; 250/282

(57) ABSTRACT

A three-dimensional chromatographic detection method providing the detection of components inside a three-dimensional separation body (1) or at a boundary surface (10) by the time the components emerge from the body.

The present invention relates to a chromatographic method in which a mobile phase passes through a separation body so as to separate components contained in the phase.

From U.S. Pat. No. 4,469,601 a chromatographic method is known which first provides a two-dimensional separation of the constituents of a solution. Such development is performed on a two-dimensional plate. After this two-dimensional development, the plate is dried. Then, the plate is placed against a cubic separation body. A mobile phase is perpendicularly introduced into the cube through the plate, and the constituents which were bound on the plate before are separated in the direction of the third dimension.

This method is also known from EP 0 060 709.

A method of this kind is complex and requires time-consuming handling, and the detection of the components in that third dimension is difficult, as well.

It is therefore the object of the invention to offer a simplified and more compact three-dimensional chromatographic method which particularly makes it easily possible to detect components in the third dimension.

The object is achieved by a chromatographic method as defined in claim 1.

The invention is based on the idea that a simplified three-dimensional chromatographic method is particularly easy to carry out if a (preferably one-piece) three-dimensional body is used for successively separating individual components in three directions of space. Contrary to the prior art, it is not necessary to successively put a two-dimensional plate and a three-dimensional separation body together.

Moreover, the method according to the invention allows to precisely and selectively detect all components or individual components when they flow out of the block. Two particularly suitable methods of detection make it possible to exactly reproduce the three-dimensional results of chromatography. For example, a precise three-dimensional image of the separation body with the spatial distribution of the components separated therein can be reproduced. Detecting the components successively flowing out of the separation body in the direction of the third dimension in intervals allows to create a three-dimensional image of the result of chromatography, too; here, the point of time at which a specific component flows out of the separation body represents the third dimension.

In the chromatographic method according to the invention, at least one mobile phase passes through a separation body, with the separation body extending in three directions (X, Y, Z) that are preferably perpendicular to one another. In each direction X, Y, Z, the body has a retention capacity that can be individually predetermined in order to chromatographically separate the components transported in a mobile phase.

According to the invention, the separation body is simultaneously or successively penetrated by at least one mobile phase in the first direction X and at least one mobile phase in the second direction Y, whereby a two-dimensional chromatographic separation of the sample supplied to the separation body is effected. The distribution thus achieved substantially extends along a plane X-Y, which preferably forms a side face of the separation body.

When the separation body is then penetrated by at least one additional mobile phase in the third direction Z according to the invention, the components that have previously been separated in the direction X-Y undergo an additional spatial separation to different positions in the Z-direction, or they undergo an additional separation as to time in such a way that they flow out of the separation body at a boundary surface at different points of time in an eluent.

For detection, the method according to the invention provides that, when components flow out in the area of the boundary surface, the components are detected continuously or at fixable points of time according to criteria to be predetermined.

This method makes it possible, also utilizing a preferably very compact separation body, to evaluate the results of three-dimensional chromatography in detail with respect to a space x space x time separation.

The invention provides that the components flowing out of the separation body are fixed on a suitable substrate. Thus, the components are advantageously detected by immobilizing them on a substrate so that the substrate can later be examined for the components with suitable methods of analysis. As the substrate, any material may be used which is capable of binding or fixing analytes emerging from the separation body. As the separation body preferably has a substantially flat boundary surface, through which the mobile phase or the components leave the separation body, a support that is equally flat is suitable in order to simultaneously absorb and fix the medium flowing out across the entire boundary surface. Fixing may particularly be effected by imprinting the boundary surface on the substrate. The components flowing out at the boundary surface are applied to the substrate in the sense of a stamp and are fixed there.

For this purpose, the separation body may be moved towards the relatively stationary substrate. Alternatively, the substrate may be placed against the boundary surface of the separation body like a paper which is pressed against a stamp, for example. In this way, a precise two-dimensional image of the components at a specific point of time t, at which these components flow to the outside through the boundary surface of the separation body, can be captured. Such form of “stamping” repeated in predefinable intervals thereby provides a three-dimensional image of how the components leave the separation body over time (which represents the third dimension here). This process of stamping makes it possible to permanently fix the individual results of chromatography over time. The images fixed on the substrate can be evaluated by known methods of analysis in order to be able to record the distribution of the individual components on each individual imprint. In known methods of analysis, particularly visible, ultraviolet or infrared light is used. Evaluating the images stored on the substrate is also easily possible by means of Raman spectroscopy or mass-spectroscopic imaging techniques.

Suitably, the separation body is configured to be monolithic for the method described above. Different retention mechanisms that might be necessary in the individual dimensions of the separation body may be defined per dimension for deliberate different selection of the components. A monolithic construction of this kind allows particularly easy and compact manufacturing of the separation body in a comparatively small space.

The method of detection (printing technique) described above may particularly effectively be used for creating three-dimensional images of the distribution of components that is achieved by chromatography. Several prints or images made at different points of time t₁, t₂, t₃ thus allow a detailed three-dimensional reconstruction of the result of chromatography. In particular, the temporal appearance of individual components in the area of the boundary surface of the separation body can be depicted in three dimensions (potentially with the aid of computers).

Other advantageous embodiments are defined in the subclaims.

In the following, a diagrammatic representation of the method of detection according to the invention will be described in greater detail with the aid of two examples shown in the Figures, where

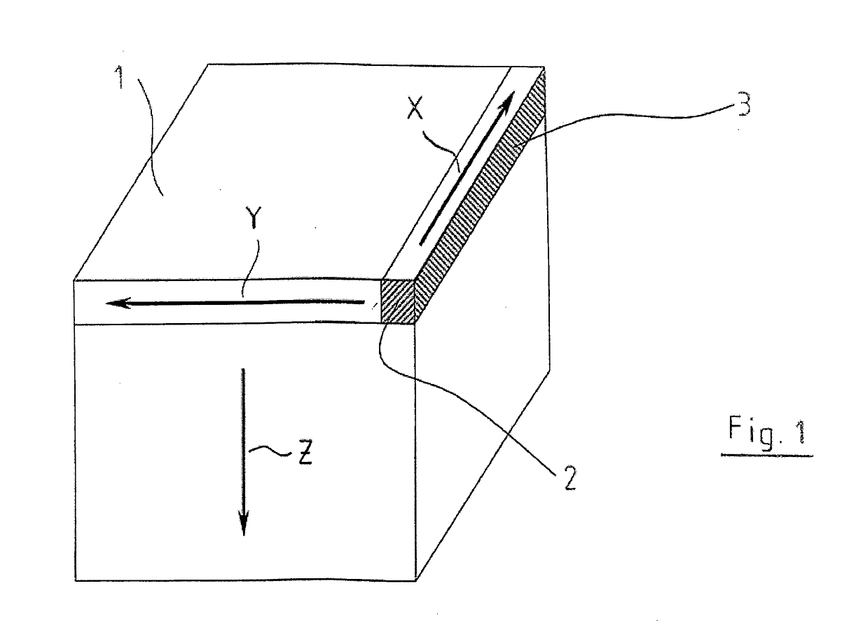

FIG. 1 shows a schematic view of a separation body, and where

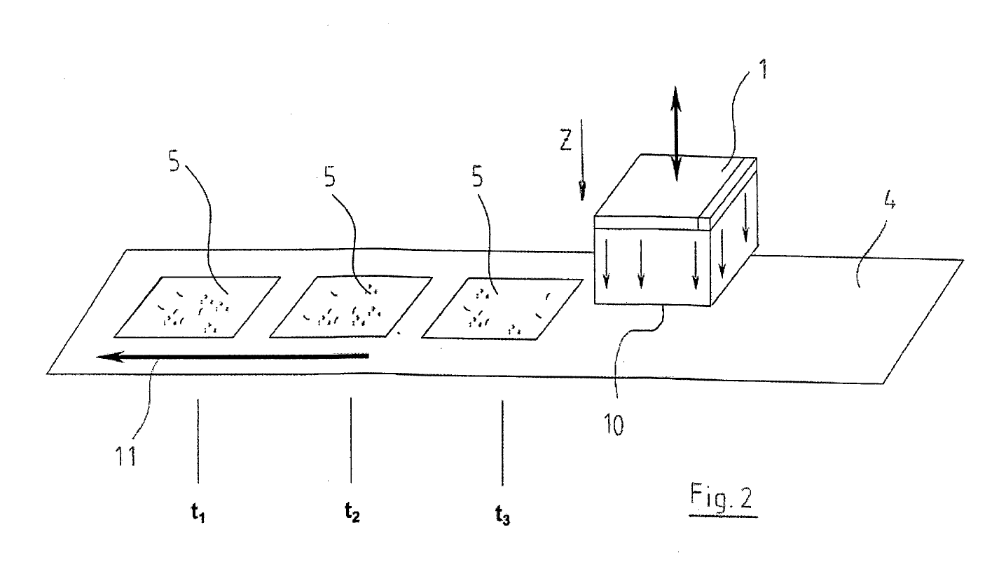

FIG. 2 illustrates how to immobilize components emerging from the body.

As shown in FIG. 1, a spatial separation body 1 according to the invention extends in three directions X, Y, Z, that are perpendicular to one another. Even though the body is designed to be monolithic, it provides a specific retention mechanism in each of the directions X, Y, Z.

To perform three-dimensional chromatography, the mobile phase is first introduced to the body through a limited upper edge area 2, which is illustrated in FIG. 1 in a disproportionate, enlarged way. Preferably, the mobile phase will penetrate the body 1 only in the first direction X during the first step of the method, along an upper edge of the body, without any mobile phase moving towards the other directions Y and Z.

During this first step, a separation of components along the X-Axis of the block will occur according to the retention mechanism foreseen in that direction. Preferably, the components will distribute individually along that first axis (“separation in space”).

After this first step, a mobile phase is introduced to penetrate the upper edge of the body 2 in the Y-direction, perpendicular to the distribution of the first step and along the entire length X through a narrow strip 3. The phase will flow in the Y-direction, preferable without any variations into the other direction X or Z, and effect an additional separation in this second dimension of those components, which were located at a specific X-position after the first step. As a result, the component will further be separated in another “separation in space” across an X-Y-Area, which could be the upper surface of the body 1 of FIG. 1.

The third separation step includes penetration of the body perpendicular to the X-Y-surface, that has undergone the previous step. A mobile phase is forced through the body in the Z-direction, causing another separation of the components which were located at specific X-Y-positions after the second step of the three-dimensional chromatography.

This separation may again occur “in space”, ending up with a distinct distribution of components along all three direction X, Y and Z of the body. Another type of separation (“in time”) occurs when the components are driven through the body entirely for this last step, but emerge from it at different points of time due to the retention mechanism chosen in that Z-direction.

The separation “in time” causes the components to leave the body through a boundary surface 10 at different points of time. One suitable way to monitor the individual components leaving the block is described in FIG. 2. There, the separation body 1 is shown while the separation in time is being performed. Accordingly, the mobile phase penetrates the body 1 in Z-direction, the components emerging from the body 1 through the lower surface 10 of the body at different points of time.

A substrate 4 is positioned under and opposite of boundary surface 10. Substrate 4 is of elongated shape and is being moved at preferably constant speed in direction 11. At preferably regular intervals, body 1 is moved up and down in Z-direction in order to contact substrate 4 (alternatively, the substrate may also be move towards the body 1). When doing so, the components emerging from body 1 at this very moment (t₁, t₂, t₃ . . . ) are being printed on substrate 4. After each print, body 1 is raised again until another print is desired. This procedure results in a series of prints 5, representing images of the components emerging from body 1 at the chosen points of time. This method allows a suitable and easy way to immobilize the components which—in turn—permits to compose a three-dimensional image of the distribution of the components for this type of three-dimensional chromatographic separation (space×space×time), the third dimension being the time axis.

The above-described method allows a fast and efficient detection of component distribution in three-dimensional chromatography.

Three-dimensional spatial chromatography may be used to tackle truly complex separation problems from areas such as systems biology. High peak-capacity separations are obtained in a reasonable time due to parallel developments. The performance of spatial 3D chromatography greatly exceeds that of LC×LC×LC based on a three-column strategy. Advantages of three-dimensional spatial chromatography can only be realized if detection can be achieved.

When working in the space×space×time domain detection can be achieved via a printing technique on a suitable substrate. The latter allows optimization/adaption of the substrate. In addition, the prints can be stored for analysis at a later time.

1. A chromatographic method in which at least one mobile phase passes through a separation body, said separation body extending in three directions (X, Y, Z) that are preferably perpendicular to one another, and said body having a retention mechanism that can be predetermined in each direction for an analyte transported in a mobile phase, wherein
a) said separation body is simultaneously or successively penetrated by at least one mobile phase in a first direction (X) and at least one mobile phase in a second direction (Y),
b) the analyte introduced into the mobile phase undergoes a separation and a distribution in the X-Y-plane,
c) said separation body is then penetrated by at least one mobile phase in a third direction (Z), with individual analytes that were separated in the X-Y plane undergoing an additional spatial separation to different positions (Z, Z₉) in the third direction (Z) and/or undergoing an additional temporal separation in which they emerge from the separation body at a boundary surface at different points of time in an eluent,
d) said components, when they emerge in the area of the boundary surface, are detected continuously or at fixable points of time according to criteria that can be predetermined, and
e) the components emerging from the separation body are fixed on a suitable substrate.

2. The chromatographic method according to claim 1, wherein fixing is effected by imprinting said boundary surface on the substrate at points of time (t₁, t₂, t₃ . . . ) that can be predetermined.

3. The chromatographic method according to claim 1, wherein a print is evaluated with the aid of visible, ultraviolet or infrared light, with the aid of Raman spectroscopy or with the aid of mass spectroscopy.

4. The chromatographic method according to claim 1, wherein the separation body is designed to be monolithic.

5. The chromatographic method according to claim 1, wherein several prints or images made at different points of time (t₁, t₂, t₃ . . . ), preferably with the aid of computers, are composed to form a three-dimensional image.
